(19) United States
(12) Patent Application Publication
(10) Pub. No.: US 2024/0349251 A1
(43) Pub. Date: Oct. 17, 2024

(54) METHODS AND APPARATUS OF DETERMINING TYPE OF UL TRANSMISSION

(71) Applicant: LENOVO (BEIJING) LIMITED, Beijing (CN)

(72) Inventors: Ran Yue, Beijing (CN); Jing Han, Beijing (CN); Haiming Wang, Beijing (CN); Lianhai Wu, Beijing (CN); Bingchao Liu, Beijing (CN)

(21) Appl. No.: 18/683,455

(22) PCT Filed: Aug. 13, 2021
(86) PCT No.: PCT/CN2021/112483

§ 371 Date: Feb. 13, 2024

(51) Int. Cl. H04W 72/04; H04L 1/1812

(52) U.S. Cl. CPC H04W 72/04; H04L 1/1812

(57) ABSTRACT

Methods and apparatus of determining type of uplink (UL) transmission are disclosed. The method performed by a terminal device in a network (NW) includes: receiving, from the network (NW), an indication that simultaneous multi-panel transmission is supported by the network (NW); determining a type of uplink (UL) transmission to be deployed, based on at least a HARQ feedback or arrival traffic; configuring one or more panels for transmission with the type of UL transmission to be deployed; and transmitting, to the network, a same transport block (TB) or different TBs via the type of UL transmission to be deployed using the one or more panels.

### FIELD

The subject matter disclosed herein relates generally to wireless communication and more particularly relates to, but not limited to, methods and apparatus of determining type of uplink (UL) transmission.

### BACKGROUND

The following abbreviations and acronyms are herewith defined, at least some of which are referred to within the specification:

Third Generation Partnership Project (3GPP), 5th Generation (5G), New Radio (NR), 5G Node B/generalized Node B (gNB), Long Term Evolution (LTE), LTE Advanced (LTE-A), E-UTRAN Node B/Evolved Node B (eNB), Universal Mobile Telecommunications System (UMTS), Worldwide Interoperability for Microwave Access (WiMAX), Evolved UMTS Terrestrial Radio Access Network (E-UTRAN), Wireless Local Area Networking (WLAN), Orthogonal Frequency Division Multiplexing (OFDM), Single-Carrier Frequency-Division Multiple Access (SC-FDMA), Downlink (DL), Uplink (UL), User Entity/Equipment (UE), Network Equipment (NE), Radio Access Technology (RAT), Receive or Receiver (RX), Transmit or Transmitter (TX), Hybrid Automatic Repeat Request (HARQ), Acknowledgement (ACK), Negative Acknowledgement (NACK), Physical Downlink Control Channel (PDCCH), Control Element (CE), Configured Grant (CG), Frequency Division Multiple Access (FDMA), Index/Identifier (ID), Industrial Internet of Things (IIoT), Media Access Control (MAC), Media Access Control-Control Element (MAC CE), Multiple Input Multiple Output (MIMO), Packet Data Convergence Protocol (PDCP), Protocol Data Unit (PDU), Physical Layer (PHY), Radio Link Control (RLC), Radio Resource Control (RRC), Reference Signal (RS), Scheduling Request (SR), Transport Block (TB), Transmission and Reception Point (TRP), Uplink Control Information (UCI), Ultra Reliable Low Latency Communications (URLLC), Frequency Range 1 (FR1), Frequency Range 2 (FR2), Logical Channel Prioritization (LCP), Network (NW), Extended Reality (XR).

In wireless communication, such as a Third Generation Partnership Project (3GPP) mobile network, a wireless mobile network may provide a seamless wireless communication service to a wireless communication terminal having mobility, i.e., user equipment (UE). The wireless mobile network may be formed of a plurality of base stations and a base station may perform wireless communication with the UEs.

The 5G New Radio (NR) is the latest in the series of 3GPP standards which supports very high data rate with lower latency compared to its predecessor LTE (4G) technology. Two types of frequency range (FR) are defined in 3GPP. Frequency of sub-6 GHz range (from 450 to 6000 MHz) is called FR1 and millimeter wave range (from 24.25 GHz to 52.6 GHZ) is called FR2. The 5G NR supports both FR1 and FR2 frequency bands.

Higher requirements for Release 18 IIoT/URLLC has been proposed, especially for the uplink enhancement. For example, supporting a group of devices to fulfill high reliability requirements in the case where a mechanical breakdown occurs, or the popularity of telehealth and Extended Reality (XR) with the aid of high-quality and low-latency techniques, or even supporting much tighter requirements for data rate, reliability and latency.

At the same time, simultaneous multi-panel transmission (TX) by UE is proposed to be studied in Release 18. The transmission can be either for diversity or for multiplexing.

### SUMMARY

Methods and apparatus of determining type of uplink (UL) transmission are disclosed.

According to a first aspect, there is provided a method performed by a terminal device in a network (NW), the method comprising: receiving, from the network (NW), an indication that simultaneous multi-panel transmission is supported by the network (NW); determining a type of uplink (UL) transmission to be deployed, based on at least a HARQ feedback or arrival traffic; configuring one or more panels for transmission with the type of UL transmission to be deployed; and transmitting, to the network, a same transport block (TB) or different TBs via the type of UL transmission to be deployed using the one or more panels.

According to a second aspect, there is provided a method performed by a base station in a network (NW), the method comprising: transmitting, to a terminal device, an indication that simultaneous multi-panel transmission is supported by the network (NW); receiving, from the terminal device, a signaling indicating a type of uplink (UL) transmission for one or more transport blocks (TBs); and receiving, from the terminal device, the one or more TBs that are transmitted with the type of UL transmission as indicated by the signaling.

According to a third aspect, there is provided an apparatus for use by a terminal device in a network (NW), the apparatus comprising: a receiver that receives, from the network (NW), an indication that simultaneous multi-panel transmission is supported by the network (NW); a processor that determines a type of uplink (UL) transmission to be deployed, based on at least a HARQ feedback or arrival traffic; wherein the processor configures one or more panels for transmission with the type of UL transmission to be deployed; and a transmitter that transmits, to the network, a same transport block (TB) or different TBs via the type of UL transmission to be deployed using the one or more panels.

According to a fourth aspect, there is provided an apparatus for use by a base station in a network (NW), the apparatus comprising: a transmitter that transmits, to a terminal device, an indication that simultaneous multi-panel transmission is supported by the network (NW); and a receiver that receives, from the terminal device, a signaling indicating a type of uplink (UL) transmission for one or more transport blocks (TBs); wherein the receiver further receives, from the terminal device, the one or more TBs that are transmitted with the type of UL transmission as indicated by the signaling.

### BRIEF DESCRIPTION OF THE DRAWINGS

A more particular description of the embodiments will be rendered by reference to specific embodiments illustrated in the appended drawings. Given that these drawings depict only some embodiments and are not therefore considered to be limiting in scope, the embodiments will be described and explained with additional specificity and details through the use of the accompanying drawings, in which:

FIG. 1 is a schematic diagram illustrating a wireless communication system in accordance with some implementations of the present disclosure;

FIG. 2 is a schematic block diagram illustrating components of user equipment (UE) in accordance with some implementations of the present disclosure;

FIG. 3 is a schematic block diagram illustrating components of network equipment (NE) in accordance with some implementations of the present disclosure;

FIG. 4 is a schematic diagram illustrating an exemplary process of determining type of uplink (UL) transmission in accordance with some implementations of the present disclosure;

FIG. 5 is a flow chart illustrating steps of determining type of uplink (UL) transmission by UE in accordance with some implementations of the present disclosure; and

FIG. 6 is a flow chart illustrating steps of determining type of uplink (UL) transmission by gNB or NE in accordance with some implementations of the present disclosure.

### DETAILED DESCRIPTION

As will be appreciated by one skilled in the art, aspects of the embodiments may be embodied as a system, an apparatus, a method, or a program product. Accordingly, embodiments may take the form of an all-hardware embodiment, an all-software embodiment (including firmware, resident software, micro-code, etc.) or an embodiment combining software and hardware aspects.

Furthermore, one or more embodiments may take the form of a program product embodied in one or more computer readable storage devices storing machine readable code, computer readable code, and/or program code, referred to hereafter as “code.” The storage devices may be tangible, non-transitory, and/or non-transmission.

Reference throughout this specification to “one embodiment,” “an embodiment,” “an example,” “some embodiments,” “some examples,” or similar language means that a particular feature, structure, or characteristic described is included in at least one embodiment or example. Thus, instances of the phrases “in one embodiment,” “in an example,” “in some embodiments,” and similar language throughout this specification may, but do not necessarily, all refer to the same embodiment(s). It may or may not include all the embodiments disclosed. Features, structures, elements, or characteristics described in connection with one or some embodiments are also applicable to other embodiments, unless expressly specified otherwise. The terms “including,” “comprising.” “having,” and variations thereof mean “including but not limited to,” unless expressly specified otherwise.

An enumerated listing of items does not imply that any or all of the items are mutually exclusive, unless expressly specified otherwise. The terms “a,” “an,” and “the” also refer to “one or more” unless expressly specified otherwise.

Throughout the disclosure, the terms “first,” “second,” “third,” and etc. are all used as nomenclature only for references to relevant devices, components, procedural steps, and etc. without implying any spatial or chronological orders, unless expressly specified otherwise. For example, a “first device” and a “second device” may refer to two separately formed devices, or two parts or components of the same device. In some cases, for example, a “first device” and a “second device” may be identical, and may be named arbitrarily. Similarly, a “first step” of a method or process may be carried or performed after, or simultaneously with, a “second step.”

It should be understood that the term “and/or” as used herein refers to and includes any and all possible combinations of one or more of the associated listed items. For example, “A and/or B” may refer to any one of the following three combinations: existence of A only, existence of B only, and co-existence of both A and B. The character “/” generally indicates an “or” relationship of the associated items. This, however, may also include an “and” relationship of the associated items. For example, “A/B” means “A or B,” which may also include the co-existence of both A and B, unless the context indicates otherwise.

Furthermore, the described features, structures, or characteristics of the embodiments may be combined in any suitable manner. In the following description, numerous specific details are provided, such as examples of programming, software modules, user selections, network transactions, database queries, database structures, hardware modules, hardware circuits, hardware chips, etc., to provide a thorough understanding of embodiments. One skilled in the relevant art will recognize, however, that embodiments may be practiced without one or more of the specific details, or with other methods, components, materials, and so forth. In other instances, well-known structures, materials, or operations are not shown or described in detail to avoid obscuring aspects of an embodiment.

Aspects of various embodiments are described below with reference to schematic flowchart diagrams and/or schematic block diagrams of methods, apparatuses, systems, and program products. It will be understood that each block of the schematic flowchart diagrams and/or schematic block diagrams, as well as combinations of blocks in the schematic flowchart diagrams and/or schematic block diagrams, may be implemented by code. This code may be provided to a processor of a general-purpose computer, special purpose computer, or other programmable data processing apparatus to produce a machine, such that the instructions executed via the processor of the computer or other programmable data processing apparatus create a means for implementing the functions or acts specified in the schematic flowchart diagrams and/or schematic block diagrams.

The code may also be stored in a storage device that can direct a computer, other programmable data processing apparatus, or other devices to function in a particular manner, such that the instructions stored in the storage device produce an article of manufacture including instructions which implement the function or act specified in the schematic flowchart diagrams and/or schematic block diagrams.

The schematic flowchart diagrams and/or schematic block diagrams in the Figures illustrate the architecture, functionality, and operation of possible implementations of different apparatuses, systems, methods, and program products according to various embodiments. In this regard, each block in the schematic flowchart diagrams and/or schematic block diagrams may represent a module, segment, or portion of code, which includes one or more executable instructions of the code for implementing the specified logical function(s). One skilled in the relevant art will recognize, however, that the flowchart diagrams need not necessarily be practiced in the sequence shown and are able to be practiced without one or more of the specific steps, or with other steps not shown.

It should also be noted that, in some alternative implementations, the functions noted in the identified blocks may occur out of the order noted in the Figures. For example, two blocks shown in succession may, in fact, be substantially executed in concurrence, or the blocks may sometimes be executed in reverse order, depending upon the functionality involved.

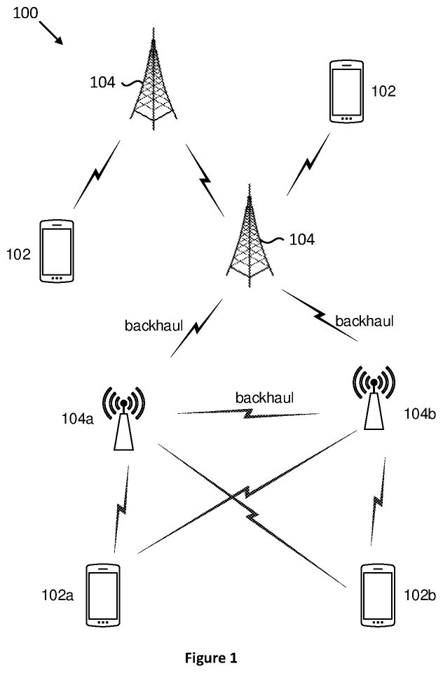

FIG. 1 is a schematic diagram illustrating a wireless communication system. It depicts an embodiment of a wireless communication system 100. In one embodiment, the wireless communication system 100 may include a user equipment (UE) 102 and a network equipment (NE) 104. Even though a specific number of UEs 102 and NEs 104 is depicted in FIG. 1, one skilled in the art will recognize that any number of UEs 102 and NEs 104 may be included in the wireless communication system 100.

The UEs 102 may be referred to as remote devices, remote units, subscriber units, mobiles, mobile stations, users, terminals, mobile terminals, fixed terminals, subscriber stations, user terminals, apparatus, devices, or by other terminology used in the art.

In one embodiment, the UEs 102 may be autonomous sensor devices, alarm devices, actuator devices, remote control devices, or the like. In some other embodiments, the UEs 102 may include computing devices, such as desktop computers, laptop computers, personal digital assistants (PDAs), tablet computers, smart phones, smart televisions (e.g., televisions connected to the Internet), set-top boxes, game consoles, security systems (including security cameras), vehicle on-board computers, network devices (e.g., routers, switches, modems), or the like. In some embodiments, the UEs 102 include wearable devices, such as smart watches, fitness bands, optical head-mounted displays, or the like. The UEs 102 may communicate directly with one or more of the NEs 104.

The NE 104 may also be referred to as a base station, an access point, an access terminal, a base, a Node-B, an eNB, a gNB, a Home Node-B, a relay node, an apparatus, a device, or by any other terminology used in the art. Throughout this specification, a reference to a base station may refer to any one of the above referenced types of the network equipment 104, such as the eNB and the gNB.

The NEs 104 may be distributed over a geographic region. The NE 104 is generally part of a radio access network that includes one or more controllers communicably coupled to one or more corresponding NEs 104. The radio access network is generally communicably coupled to one or more core networks, which may be coupled to other networks, like the Internet and public switched telephone networks. These and other elements of radio access and core networks are not illustrated, but are well known generally by those having ordinary skill in the art.

In one implementation, the wireless communication system 100 is compliant with a 3GPP 5G new radio (NR). In some implementations, the wireless communication system 100 is compliant with a 3GPP protocol, where the NEs 104 transmit using an OFDM modulation scheme on the DL and the UEs 102 transmit on the uplink (UL) using a SC-FDMA scheme or an OFDM scheme. More generally, however, the wireless communication system 100 may implement some other open or proprietary communication protocols, for example, WiMAX. The present disclosure is not intended to be limited to the implementation of any particular wireless communication system architecture or protocol.

The NE 104 may serve a number of UEs 102 within a serving area, for example, a cell (or a cell sector) or more cells via a wireless communication link. The NE 104 transmits DL communication signals to serve the UEs 102 in the time, frequency, and/or spatial domain.

Communication links are provided between the NE 104 and the UEs 102a, 102b. 102c, and 102d, which may be NR UL or DL communication links, for example. Some UEs 102 may simultaneously communicate with different Radio Access Technologies (RATs), such as NR and LTE. Direct or indirect communication link between two or more NEs 104 may be provided.

The NE 104 may also include one or more transmit receive points (TRPs) 104a. In some embodiments, the network equipment may be a gNB 104 that controls a number of TRPs 104a. In addition, there is a backhaul between two TRPs 104a. In some other embodiments, the network equipment may be a TRP 104a that is controlled by a gNB.

Communication links are provided between the NEs 104, 104a and the UEs 102, 102a, respectively, which, for example, may be NR UL/DL communication links. Some UEs 102, 102a may simultaneously communicate with different Radio Access Technologies (RATs), such as NR and LTE.

In some embodiments, the UE 102a may be able to communicate with two or more TRPs 104a that utilize a non-ideal backhaul, simultaneously. A TRP may be a transmission point of a gNB. Multiple beams may be used by the UE and/or TRP(s). The two or more TRPs may be TRPs of different gNBs, or a same gNB. That is, different TRPs may have the same Cell-ID or different Cell-IDs. The terms “TRP” and “transmitting-receiving identity” may be used interchangeably throughout the disclosure.

The technology disclosed, or at least some of the examples, may be applicable to scenarios with multiple TRPs or without multiple TRPs, as long as multiple PDCCH transmissions are supported.

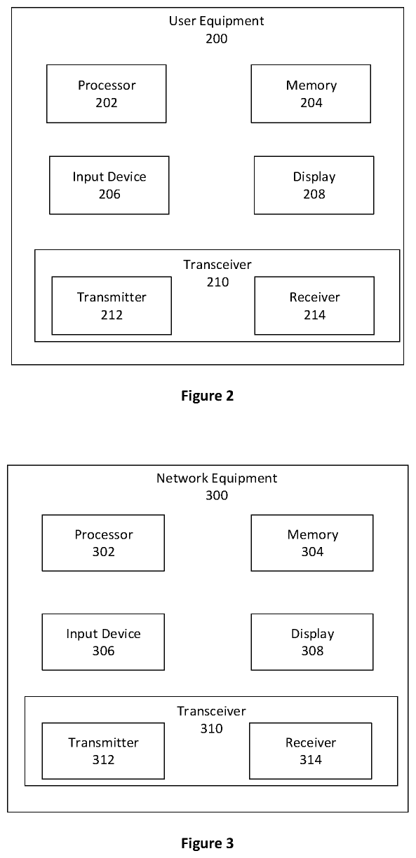

FIG. 2 is a schematic block diagram illustrating components of user equipment (UE) according to one embodiment. A UE 200 may include a processor 202, a memory 204, an input device 206, a display 208, and a transceiver 210. In some embodiments, the input device 206 and the display 208 are combined into a single device, such as a touchscreen. In certain embodiments, the UE 200 may not include any input device 206 and/or display 208. In various embodiments, the UE 200 may include one or more processors 202 and may not include the input device 206 and/or the display 208.

The processor 202, in one embodiment, may include any known controller capable of executing computer-readable instructions and/or capable of performing logical operations. For example, the processor 202 may be a microcontroller, a microprocessor, a central processing unit (CPU), a graphics processing unit (GPU), an auxiliary processing unit, a field programmable gate array (FPGA), or similar programmable controller. In some embodiments, the processor 202 executes instructions stored in the memory 204 to perform the methods and routines described herein. The processor 202 is communicatively coupled to the memory 204 and the transceiver 210.

The memory 204, in one embodiment, is a computer readable storage medium. In some embodiments, the memory 204 includes volatile computer storage media. For example, the memory 204 may include a RAM, including dynamic RAM (DRAM), synchronous dynamic RAM (SDRAM), and/or static RAM (SRAM). In some embodiments, the memory 204 includes non-volatile computer storage media. For example, the memory 204 may include a hard disk drive, a flash memory, or any other suitable non-volatile computer storage device. In some embodiments, the memory 204 includes both volatile and non-volatile computer storage media. In some embodiments, the memory 204 stores data relating to trigger conditions for transmitting the measurement report to the network equipment. In some embodiments, the memory 204 also stores program code and related data.

The input device 206, in one embodiment, may include any known computer input device including a touch panel, a button, a keyboard, a stylus, a microphone, or the like. In some embodiments, the input device 206 may be integrated with the display 208, for example, as a touchscreen or similar touch-sensitive display.

The display 208, in one embodiment, may include any known electronically controllable display or display device. The display 208 may be designed to output visual, audio, and/or haptic signals.

The transceiver 210, in one embodiment, is configured to communicate wirelessly with the network equipment. In certain embodiments, the transceiver 210 comprises a transmitter 212 and a receiver 214. The transmitter 212 is used to transmit UL communication signals to the network equipment and the receiver 214 is used to receive DL communication signals from the network equipment.

The transmitter 212 and the receiver 214 may be any suitable type of transmitters and receivers. Although only one transmitter 212 and one receiver 214 are illustrated, the transceiver 210 may have any suitable number of transmitters 212 and receivers 214. For example, in some embodiments, the UE 200 includes a plurality of the transmitter 212 and the receiver 214 pairs for communicating on a plurality of wireless networks and/or radio frequency bands, with each of the transmitter 212 and the receiver 214 pairs configured to communicate on a different wireless network and/or radio frequency band.

FIG. 3 is a schematic block diagram illustrating components of network equipment (NE) 300 according to one embodiment. The NE 300 may include a processor 302, a memory 304, an input device 306, a display 308, and a transceiver 310. As may be appreciated, the processor 302, the memory 304, the input device 306, the display 308, and the transceiver 310 may be similar to the processor 202, the memory 204, the input device 206, the display 208, and the transceiver 210 of the UE 200, respectively.

In some embodiments, the processor 302 controls the transceiver 310 to transmit DL signals or data to the UE 200. The processor 302 may also control the transceiver 310 to receive UL signals or data from the UE 200. In another example, the processor 302 may control the transceiver 310 to transmit DL signals containing various configuration data to the UE 200.

In some embodiments, the transceiver 310 comprises a transmitter 312 and a receiver 314. The transmitter 312 is used to transmit DL communication signals to the UE 200 and the receiver 314 is used to receive UL communication signals from the UE 200.

The transceiver 310 may communicate simultaneously with a plurality of UEs 200. For example, the transmitter 312 may transmit DL communication signals to the UE 200. As another example, the receiver 314 may simultaneously receive UL communication signals from the UE 200. The transmitter 312 and the receiver 314 may be any suitable type of transmitters and receivers. Although only one transmitter 312 and one receiver 314 are illustrated, the transceiver 310 may have any suitable number of transmitters 312 and receivers 314. For example, the NE 300 may serve multiple cells and/or cell sectors, where the transceiver 310 includes a transmitter 312 and a receiver 314 for each cell or cell sector.

Referring to Release 16 or Release 17 IIoT, both dynamic grant and multiple configured grant (CG) configurations are supported to meet the very tight latency requirements. Therefore, it makes sense to apply multi-panel TX on the dynamic grant and configured grant for Release18 IIoT/URLLC.

For dynamic grant, or grant-based (GB) UL transmission, one or more dynamic UL grants are transmitted to the UE, based upon a service request (SR) from the UE to a base station. The process may include: transmitting an SR from the UE to a base station, receiving from the base station one or more UL grants corresponding to the SR, and transmitting by the UE one or more transport blocks based on the received one or more dynamic UL grants.

For configured grant (CG), uplink (UL) transmission is carried with pre-allocated resources once there is data to be transmitted, without the need of a dynamic grant. A base station may allocate to the UE one or more configured grant radio resources. The UE may be configured by the base station to use the configured grant radio resources to transmit, via the configured grant radio resources without a dynamic UL grant, one or more data packets.

For multiple-TRP (mTRP) system, multi-panel transmission from the UE is also supported. There are several types of UL transmissions the UE may use to transmit one or more transport blocks (TBs) to the network (NW), e.g., a diversity type transmission, and a multiplexing type transmission.

For diversity, the same TB is repeated on multiple panels (also applied for HST for UL). For multiplexing, different MIMO layers are transmitted on different panels.

Each type of UL transmission may provide a better performance for a different scenario. Selection from the different types of UL transmissions may be based on a tradeoff between capacity and reliability. Autonomous transmission type switching between diversity and multiplexing may provide better performance and meet various requirements for Release 18 IIoT/URLLC.

Switching Between Diversity and Multiplexing when Transmission on CG Resources

Diversity and multiplexing are necessary for meeting the various requirements of IIoT, but the two types of UL transmissions are applied in different scenarios.

In the disclosure, the trigger conditions for the autonomous transmission type switching and the corresponding indication of which type is used for the transmission are proposed to enhance the CG transmission.

In addition, some traffics require high data rate, but others require high reliability. However, the dynamic scheduled grant is per UE. Thus, which transmission type is suitable for the traffic is not taken into account when UE assembles a PDU according to the existing principles. In the discourse, this factor is considered.

Furthermore, the related configuration of the repeated transmissions and how to obtain the repeated PDU are taken into account when the diversity transmission type is applied.

The UE may receive from the NW an indication that simultaneous multi-panel transmission is supported by the NW. The indication may be that the NW supports multi-panel transmission or multi-TRP reception, or the NW configures the related resources to support multi-panel transmission, or the NW indicates which panels are allowed to perform multi-panel transmission, or the NW indicates that the UE is allowed to decide autonomously single-panel or multi-panel transmission is performed, etc. The indication can be implicit or explicit. In the following discussion, it is assumed that simultaneous multi-panel transmission is supported by the network.

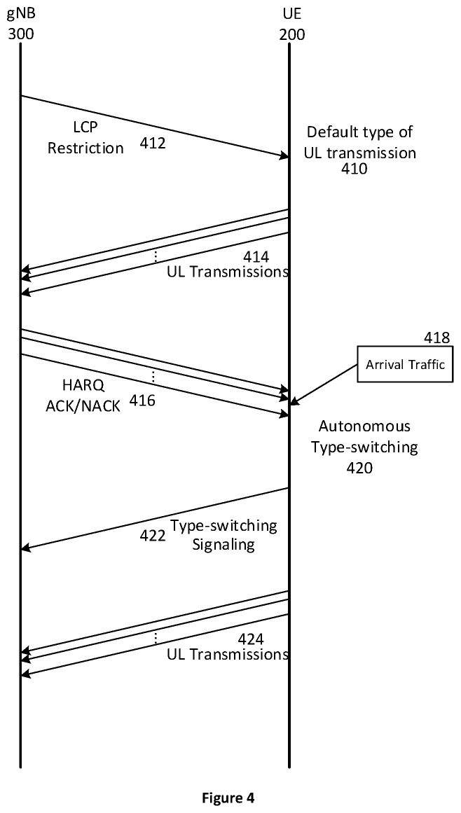

FIG. 4 is a schematic diagram illustrating an exemplary process of determining type of uplink (UL) transmission in accordance with some implementations of the present disclosure. The UE 200 may be provided with a default configuration, or default type of UL transmission 410, that is initially defined or configured. In some cases, the default type of UL transmission to the network may be a diversity type transmission, a multiplexing type transmission, or a single panel transmission.

In the example of FIG. 4, a default transmission type (or initial transmission type) of multiplexing or diversity 410 may be configured or defined once multi-panel transmission is enabled without special statement for the transmission type. In another example, the default transmission type 410 may be configured or defined once multi-panel transmission on CG resources is enabled. In another example, the default transmission type 410 may be configured or defined once multi-panel transmission per HARQ process is enabled. In another example, the default transmission type 410 may be configured or defined once multi-panel transmission per UE is enabled. In another example, the default transmission type 410 may be configured or defined once multi-panel transmission per MAC entity, or per UL grant is enabled. In another example, the default transmission type 410 may be configured or defined once multi-panel transmission per UL grant is enabled. The default or initial transmission type may be configured when the CG resource is configured with multi-panel or mTRP transmission.

The UE 200 may receive a parameter (for example, LCP restriction) 412 from the gNB 300. The parameter may be configured to select the logical channels for the UL grant that satisfy the conditions such as the set of the allowed type (i.e., diversity and/or multiplexing), and same or different TBs indication for transmission in a new configured parameter. The new parameter, if configured, may include the type (i.e., diversity and/or multiplexing) and same or different TBs indication for transmission associated to the UL grant. The parameter may indicate one or more allowable types of transmissions associated with a UL grant, for selecting logical channels.

Autonomous type-switching 420 of UL transmission may be performed based on a determination of type of uplink (UL) transmission to be deployed for one or more upcoming UL transmissions 424. The transmission type may be autonomously switched once one or more of the following conditions (or trigger conditions) are satisfied:
a) NACK indication is received 416 by the UE for an earlier UL transmission 414 (which may be of the default transmission type, or the initial transmission type if no switching has ever been performed, or the transmission type which is different from the initial or default transmission type), including HARQ NACK indication, dynamic scheduling for reTX (retransmission), cg-RetransmissionTimer expiry, declaring into survival time, declaring into urgent state, RLC/PDCP status report indicating NACK, etc. After receiving the NACK indication, the following transmission 424 of the logical channel on CG to multiple TRPs (mTRPs) will be the diversity type transmission. That is, the type of UL transmission to be deployed is determined to be the diversity type after reception of NACK indication. Thus, if the type of UL transmission of the previous transmission (e.g. the earlier transmission 414) differs from the diversity type transmission, switching to the diversity type transmission is performed.
b) ACK indication for the HARQ process or its replicated process is received 416 by the UE for an earlier UL transmission 414, including HARQ ACK indication, configuredGrantTimer expiry, declaring into non-survival time, declaring into non-urgent state, RLC/PDCP status report indicating ACK, etc. After receiving the ACK indication, the following transmission 424 of the logical channel on CG to mTRPs will be the multiplexing type transmission. That is, the type of UL transmission to be deployed is determined to be the multiplexing type after reception of ACK indication. Thus, if the type of UL transmission of the previous transmission differs from the multiplexing type transmission, switching to the multiplexing type transmission is performed.
c) NACK indication is received 416 by the UE for an earlier UL transmission 414, including HARQ NACK indication, dynamic scheduling for reTX, cg-RetransmissionTimer expiry, declaring into survival time, declaring into urgent state, RLC/PDCP status report indicating NACK, etc. After receiving the NACK indication, the following transmission 424 of the logical channel on CG to mTRPs will be the multiplexing type transmission. That is, the type of UL transmission to be deployed is determined to be the multiplexing type after reception of NACK indication. Thus, if the type of UL transmission of the previous transmission differs from the multiplexing type transmission, switching to the multiplexing type transmission is performed.
d) ACK indication for the HARQ process or its replicated process is received 416 by the UE for an earlier UL transmission 414, including HARQ ACK indication, configuredGrantTimer expiry, declaring into non-survival time, declaring into non-urgent state, RLC/PDCP status report indicating ACK, etc. After receiving the ACK indication, the following transmission 424 of the logical channel on CG to mTRPs will be the diversity type transmission. That is, the type of UL transmission to be deployed is determined to be the diversity type after reception of ACK indication. Thus, if the type of UL transmission of the previous transmission differs from the diversity type transmission, switching to the diversity type transmission is performed.
e) The traffic arrives 418. The type of transmission indicated by the configured parameter (for example, LCP restriction) will be applied if the parameter is configured to the logical channel corresponding to the arrival traffic, and the following transmission 424 of the logical channel on multiple panels to mTRPs will be transmission of the indicated type. That is, the type of UL transmission to be deployed is determined based on the arrival traffic, more specifically, it is determined to be the transmission type indicated by the configured parameter.

For the conditions a) to d), it is possible that the determination of the type of UL transmission to be deployed or the switching is performed after a number of ACK or NACK indications are received.

The following transmission 424 referred to in the above conditions may be any one of the following: new transmission, retransmission, autonomous transmission, or autonomous retransmission.

The corresponding indication of which type is used for the following transmission 424 will be indicated to the NW. The indication, or type-switching signaling 422, may be carried by UCI, or a separate PDU, or a separate MAC CE, or by PHY layer.

The UE may be configured with one or more panels for transmission with the type of UL transmission to be deployed, and transmits, to the network, a same transport block (TB) or different TBs via the type of UL transmission to be deployed using the one or more panels.

The UE may be configured with a primary panel. The configuration (e.g., an RRC signaling configuration) received from the NW may indicate that a primary panel is used for transmission of the same or different TBs.

The UE may also be configured with one or more secondary panels. The configuration (e.g., an RRC signaling configuration) received from the NW may indicate that one or more secondary panels are used for transmission of the same or different TBs.

When it is determined that the diversity type of transmission will be used or switched to, the UE may apply the corresponding configurations for the diversity type of UL transmission. The configuration may be based on a predefined rule or may be up to UE implementation.

For the secondary panel(s) or for the repeated PDU, the UE may obtain the MAC PDU to transmit from the HARQ process corresponding to the primary panel when the diversity type transmission is used by UE.

In some examples, the UE may be configured with the primary panel by configuring one primary RS set, Beam set, panel, or TRP, and the corresponding index or ID (for example panel #1 or TRP #1) when configuring the simultaneous multi-panel transmission. In another example, the UE may be configured with the primary panel by configuring one primary RS set, Beam set, panel, or TRP, per serving cell. In another example, the UE may be configured with the primary panel by configuring one primary RS set, Beam set, panel, or TRP, per MAC entity. In another example, the UE may be configured with the primary panel by configuring one primary RS set, Beam set, panel, or TRP, per UE).

The UE may further configure one or more secondary panels by configuring one or more secondary RS sets, Beam sets, panels, or TRPs (per serving cell or per MAC entity or per UE), and the corresponding index or ID (for example panel #2 or TRP #2).

Optionally, the HARQ process ID or HARQ process ID group or HARQ process ID set corresponding to the primary or secondary RS set(s), or Beam set(s), or panel(s), or TRP(s) may be configured. Some examples may include: the HARQ process ID corresponding to the primary RS set are configured; the HARQ process ID group corresponding to the secondary Beam sets are configured; the HARQ process ID set corresponding to the secondary TRPs are configured; etc.

Optionally, the offset of the HARQ process ID or HARQ process ID group or HARQ process ID set between the primary and the secondary RS set(s), or Beam set(s), or panel(s), or TRP(s) may be configured or defined. Some examples may include: offset of the HARQ process ID corresponding to the primary RS set are configured; the offset of the HARQ process ID group corresponding to the secondary Beam sets are configured; the offset of the HARQ process ID set corresponding to the secondary TRPs are configured; etc.

The above configuration can be associated with a configured grant configuration, which may be the configuration per HARQ process, per UE, per MAC entity, or per UL grant.

CG HARQ Process when Applying Multi-Panel TX for Diversity or Multiplexing

The multi-panel UL transmission may be the simultaneous transmission of same or different TBs from different panels by UE. It may be uncertain whether the TBs are the same or different before the TBs are received. Therefore, it may be better to define two HARQ process IDs for the same CG resource from the view of HARQ process modeling.

The existing HARQ process ID for CG only takes the time and frequency fields into account, while the spatial field is not considered. In the disclosure, designs are proposed on how to define and calculate the HARQ process ID, considering the simultaneous multi-panel TX by UE.

The benefit of soft combination is expected by receiving from the same HARQ process when the repeated TBs are transmitted. Assuming the same HARQ ID is used when transmitting multiple same TBs, the receiver may deliver all of them to the same HARQ buffer since all of them are considered as the new transmissions from the same HARQ process. Then, the TB(s) except the last handled one will be flushed by the later TB referring to the existing HARQ operation. Thus, enhancement is proposed.

In some examples, different HARQ processes (HARQ process IDs) are configured or defined for the simultaneous multi-panel TX by UE, including the case where the same TBs are simultaneous transmitted.

The spatial field, which is also taken into account when deciding the HARQ process ID of the CG, may include RS set index (ID) configured for TRP, TRP index (ID), or panel index (ID), etc. The spatial field is used for the simultaneous transmission, since it is possible to transmit simultaneously to mTRPs.

The HARQ process ID may be calculated based on one of the following equations:

a) HARQ Process ID=[floor(CURRENT_symbol/periodicity)+panel ID]modulo nrofHARQ-Processes

b) HARQ Process ID=[floor(CURRENT_symbol/periodicity)+panel ID]modulo nrofHARQ-Processes-formultipanel

c) HARQ Process ID=[floor(CURRENT_symbol/periodicity)+panel ID]modulo nrofHARQ-Processes+harq-ProclD-Offset2

d) HARQ Process ID=[floor(CURRENT_symbol/periodicity)+panel ID]modulo nrofHARQ-Processes+harq-ProcID-Offset2-formultipanel.

Instead of using panel ID, the HARQ process ID may be calculated based on similar equations using RS set index (ID) configured for TRP, or TRP index (ID), etc.

In some other examples, the same HARQ process may be configured or defined for the same TBs which are simultaneously transmitted by multi-panel TX. If the spatial field is considered when deciding the HARQ process ID of the CG, the primary panel, secondary panels, or any of the RS set index (ID) configured for TRP, TRP index (ID), or panel index (ID), etc., which is used for the simultaneous transmission, may be used for the calculation of HARQ process ID. One TB, or the TB from the primary RS set, Beam set, panel, or TRP, is a new transmission, while the other TB(s), or the TB(s) from the secondary RS set(s), Beam set(s), panel(s), or TRP(s), is or are retransmission(s). That is, the transmission from primary panel is configured for new transmission of the same or different TBs; and the transmission from one or more secondary panels are configured for one or more retransmissions of the same or different TBs. or the transmission from one panel is configured for new transmission of the same or different TBs; and the transmission from other panels are configured for retransmissions of the same or different TBs. The same HARQ process is associated with the new transmission and the retransmissions.

In some yet further examples, different HARQ processes may be configured or defined for the same TBs' simultaneous multi-panel TX by UE. The UE may start, restart, or stop the other configuredGrantTimer accordingly if the corresponding HARQ process of one panel is considered as having been successfully transmitted. For example, the configuredGrantTimer for the corresponding HARQ process of one panel is started or restarted for a new transmission, or DFI is received to indicate ACK, etc. The UE may stop the other cg-RetransmissionTimer accordingly if the corresponding HARQ process of one panel is considered as having been successfully transmitted. For example, the cg-RetransmissionTimer for the corresponding HARQ process of one panel is stopped for a new transmission and it is running for the others, or DFI is received to indicate ACK, etc.

FIG. 5 is a flow chart illustrating steps of determining type of uplink (UL) transmission by UE 200 in accordance with some implementations of the present disclosure.

At step 502, the receiver 214 of UE 200 receives, from the network (NW), an indication that simultaneous multi-panel transmission is supported by the network (NW).

At step 504, the processor 202 of UE 200 determines a type of uplink (UL) transmission to be deployed, based on at least a HARQ feedback or arrival traffic.

At step 506, the processor 202 of UE 200 configures one or more panels for transmission with the type of UL transmission to be deployed.

At step 508, the transmitter 212 of UE 200 transmits, to the network, a same transport block (TB) or different TBs via the type of UL transmission to be deployed using the one or more panels.

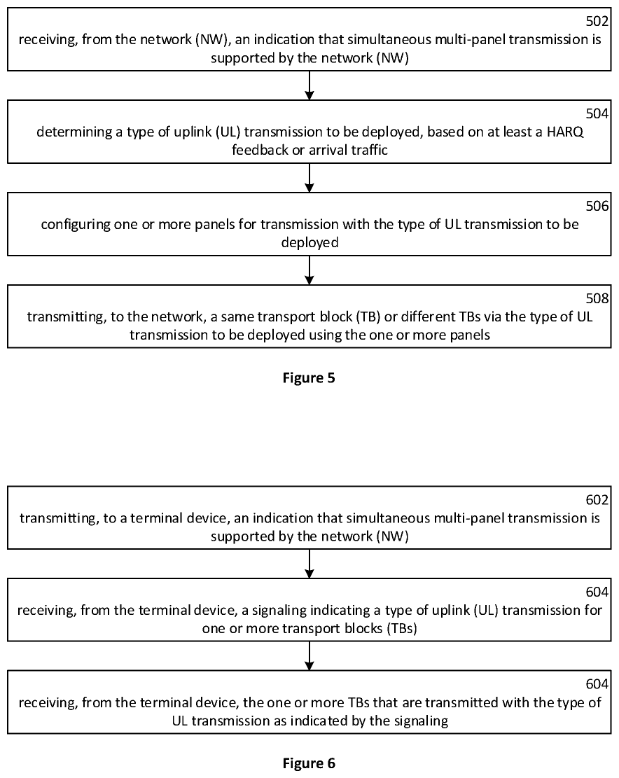

FIG. 6 is a flow chart illustrating steps of determining type of uplink (UL) transmission by gNB or NE 300 in accordance with some implementations of the present disclosure.

At step 602, the transmitter 312 of NE 300 transmits, to a terminal device (e.g., UE), an indication that simultaneous multi-panel transmission is supported by the network (NW).

At step 604, the receiver 314 of NE 300 receives, from the terminal device, a signaling indicating a type of uplink (UL) transmission for one or more transport blocks (TBs).

At step 606, the receiver 314 of NE 300 further receives, from the terminal device, the one or more TBs that are transmitted with the type of UL transmission as indicated by the signaling.

In one aspect, some items as examples of the disclosure concerning a method of a UE or remote device may be summarized as follows:
1. A method performed by a terminal device in a network (NW), the method comprising:
receiving, from the network (NW), an indication that simultaneous multi-panel transmission is supported by the network (NW);
determining a type of uplink (UL) transmission to be deployed, based on at least a HARQ feedback or arrival traffic;
configuring one or more panels for transmission with the type of UL transmission to be deployed; and
transmitting, to the network, a same transport block (TB) or different TBs via the type of UL transmission to be deployed using the one or more panels.
2. The method of claim 1, further comprising determining one or more HARQ process indexes (IDs) to support the transmission of the same or different TBs, based on the type of UL transmission as determined.
3. The method of claim 1, wherein the type of UL transmission to be deployed
comprises at least one of: a diversity type transmission, and a multiplexing type transmission.
4. The method of claim 1, wherein the determining the type of UL transmission to be deployed based on the arrival traffic comprises determining the type of UL transmission to be deployed based on a configured Logical Channel Prioritization (LCP) restriction.
5. The method of claim 1, wherein a default type of UL transmission to the network comprises one of: a diversity type transmission, a multiplexing type transmission, and a single panel transmission.
6. The method of claim 1 or 5, wherein upon determining that the type of UL transmission to be deployed differs from a type of UL transmission of a previous transmission or from the default type of UL transmission, switching to the type of UL transmission to be deployed.
7. The method of claim 1, further comprising receiving information from the NW associated with using a primary panel for a first transmission of the same or different TBs.
8. The method of claim 1, further comprising receiving information from the NW associated with using a primary panel for a first transmission of the same or different TBs to support the type of UL transmission to be deployed.
9. The method of claim 1, further comprising receiving information from the NW associated with using one or more secondary panels for one or more second transmissions of the same or different TBs.
10. The method of claim 1, further comprising receiving information from the NW associated with using one or more secondary panels for one or more second transmissions of the same or different TBs to support the type of UL transmission to be deployed.
11. The method of any one of claims 7 to 10, wherein the information is an RRC signaling configuration.
12. The method of any one of claims 7 to 10, wherein the first transmission is a new transmission of the same or different TBs and the second transmissions are retransmissions of the same or different TBs; and the same HARQ process is associated with the first transmission and the second transmissions.
13. The method of claim 1, further comprising transmitting to the network (NW) a signaling indicating the type of UL transmission to be deployed.

In another aspect, some items as examples of the disclosure concerning a method of a NE or gNB may be summarized as follows:
14. A method performed by a base station in a network (NW), the method comprising:
transmitting, to a terminal device, an indication that simultaneous multi-panel transmission is supported by the network (NW);
receiving, from the terminal device, a signaling indicating a type of uplink (UL) transmission for one or more transport blocks (TBs); and
receiving, from the terminal device, the one or more TBs that are transmitted with the type of UL transmission as indicated by the signaling.
15. The method of claim 14, further comprising determining one or more HARQ process indexes (IDs) to support the transmission of the same or different TBs, based on the type of UL transmission.
16. The method of claim 14, wherein the type of UL transmission comprises at least one of: a diversity type transmission, and a multiplexing type transmission.
17. The method of claim 14, further comprising configuring a Logical Channel Prioritization (LCP) restriction for the terminal device, based on which the terminal device determines the type of UL transmission.
18. The method of claim 14, wherein a default type of UL transmission to the network comprises one of: a diversity type transmission, a multiplexing type transmission, and a single panel transmission.
19. The method of claim 14 or 18, wherein upon receiving the signaling indicating the type of UL transmission that differs from a type of UL transmission of a previous transmission or from the default type of UL transmission, configuring the terminal device to switch to the type of UL transmission.
20. The method of claim 14, further comprising transmitting to the terminal device information associated with using a primary panel for a first transmission of the same or different TBs from the terminal device.
21. The method of claim 14, further comprising transmitting to the terminal device information associated with using a primary panel for a first transmission of the same or different TBs to support the type of UL transmission.
22. The method of claim 14, further comprising transmitting to the terminal device information associated with using one or more secondary panels for one or more second transmissions of the same or different TBs from the terminal device.
23. The method of claim 14, further comprising transmitting to the terminal device information associated with using one or more secondary panels for one or more second transmissions of the same or different TBs to support the type of UL transmission.
24. The method of any one of claims 20 to 23, wherein the information is an RRC signaling configuration.
25. The method of any one of claims 20 to 23, wherein the first transmission is a new transmission of the same or different TBs and the second transmissions are retransmissions of the same or different TBs; and the same HARQ process is associated with the first transmission and the second transmissions.

In a further aspect, some items as examples of the disclosure concerning a UE or remote device may be summarized as follows:
26. An apparatus for use by a terminal device in a network (NW), the apparatus comprising:
a receiver that receives, from the network (NW), an indication that simultaneous multi-panel transmission is supported by the network (NW);
a processor that determines a type of uplink (UL) transmission to be deployed, based on at least a HARQ feedback or arrival traffic; wherein the processor configures one or more panels for transmission with the type of UL transmission to be deployed; and
a transmitter that transmits, to the network, a same transport block (TB) or different TBs via the type of UL transmission to be deployed using the one or more panels.
27. The apparatus of claim 26, wherein the processor further determines one or more HARQ process indexes (IDs) to support the transmission of the same or different TBs, based on the type of UL transmission as determined.
28. The apparatus of claim 26, wherein the type of UL transmission to be deployed comprises at least one of: a diversity type transmission, and a multiplexing type transmission.
29. The apparatus of claim 26, wherein the determining the type of UL transmission to be deployed based on the arrival traffic comprises determining the type of UL transmission to be deployed based on a configured Logical Channel Prioritization (LCP) restriction.
30. The apparatus of claim 26, wherein a default type of UL transmission to the network comprises one of: a diversity type transmission, a multiplexing type transmission, and a single panel transmission.
31. The apparatus of claim 26 or 30, wherein upon determining that the type of UL transmission to be deployed differs from a type of UL transmission of a previous transmission or from the default type of UL transmission, switching to the type of UL transmission to be deployed.
32. The apparatus of claim 26, wherein the receiver further receives information from the NW associated with using a primary panel for a first transmission of the same or different TBs.
33. The apparatus of claim 26, wherein the receiver further receives information from the NW associated with using a primary panel for a first transmission of the same or different TBs to support the type of UL transmission to be deployed.
34. The apparatus of claim 26, wherein the receiver further receives information from the NW associated with using one or more secondary panels for one or more second transmissions of the same or different TBs.
35. The apparatus of claim 26, wherein the receiver further receives information from the NW associated with using one or more secondary panels for one or more second transmissions of the same or different TBs to support the type of UL transmission to be deployed.
36. The apparatus of any one of claims 32 to 35, wherein the information is an RRC signaling configuration.
37. The apparatus of any one of claims 32 to 35, wherein the first transmission is a new transmission of the same or different TBs and the second transmissions are retransmissions of the same or different TBs; and the same HARQ process is associated with the first transmission and the second transmissions.
38. The apparatus of claim 26, wherein the transmitter further transmits to the network (NW) a signaling indicating the type of UL transmission to be deployed.

In a yet further aspect, some items as examples of the disclosure concerning a NE or gNB may be summarized as follows:
39. An apparatus for use by a base station in a network (NW), the apparatus comprising:
a transmitter that transmits, to a terminal device, an indication that simultaneous multi-panel transmission is supported by the network (NW); and
a receiver that receives, from the terminal device, a signaling indicating a type of uplink (UL) transmission for one or more transport blocks (TBs);
wherein the receiver further receives, from the terminal device, the one or more TBs that are transmitted with the type of UL transmission as indicated by the signaling.
40. The apparatus of claim 39, further comprising a processor that determines one or more HARQ process indexes (IDs) to support the transmission of the same or different TBs, based on the type of UL transmission.
41. The apparatus of claim 39, wherein the type of UL transmission comprises at least one of: a diversity type transmission, and a multiplexing type transmission.
42. The apparatus of claim 39, further comprising a processor that configures a Logical Channel Prioritization (LCP) restriction for the terminal device, based on which the terminal device determines the type of UL transmission.
43. The apparatus of claim 39, wherein a default type of UL transmission to the network comprises one of: a diversity type transmission, a multiplexing type transmission, and a single panel transmission.
44. The apparatus of claim 39 or 43, wherein upon receiving the signaling indicating the type of UL transmission that differs from a type of UL transmission of a previous transmission or from the default type of UL transmission, the transmitter transmits a configuration to the terminal device to switch to the type of UL transmission.
45. The apparatus of claim 39, wherein the transmitter further transmits to the terminal device information associated with using a primary panel for a first transmission of the same or different TBs from the terminal device.
46. The apparatus of claim 39, wherein the transmitter further transmits to the terminal device information associated with using a primary panel for a first transmission of the same or different TBs to support the type of UL transmission.
47. The apparatus of claim 39, wherein the transmitter further transmits to the terminal device information associated with using one or more secondary panels for one or more second transmissions of the same or different TBs from the terminal device.
48. The apparatus of claim 39, wherein the transmitter further transmits to the terminal device information associated with using one or more secondary panels for one or more second transmissions of the same or different TBs to support the type of UL transmission.
49. The apparatus of any one of claims 45 to 48, wherein the information is an RRC signaling configuration.
50. The apparatus of any one of claims 45 to 48, wherein the first transmission is a new transmission of the same or different TBs and the second transmissions are retransmissions of the same or different TBs; and the same HARQ process is associated with the first transmission and the second transmissions.

Various embodiments and/or examples are disclosed to provide exemplary and explanatory information to enable a person of ordinary skill in the art to put the disclosure into practice. Features or components disclosed with reference to one embodiment or example are also applicable to all embodiments or examples unless specifically indicated otherwise.

Embodiments may be practiced in other specific forms. The described embodiments are to be considered in all respects only as illustrative and not restrictive. The scope is, therefore, indicated by the appended claims rather than by the foregoing description. All changes which come within the meaning and range of equivalency of the claims are to be embraced within their scope.

1. A method performed by a user equipment (UE), the method comprising:
receiving, from a network (NW), an indication that simultaneous multi-panel transmission is supported by the NW;
determining a type of uplink (UL) transmission to be deployed, based on at least a hybrid automatic repeat request (HARQ) feedback or arrival traffic;
configuring one or more panels for transmission with the type of UL transmission to be deployed; and
transmitting, to the NW, a same transport block (TB) or different TBs via the type of UL transmission to be deployed using the one or more panels.

2. The method of claim 1, further comprising determining one or more HARQ process indexes (IDs) to support the transmission of the same or different TBs, based on the type of UL transmission as determined.

3. The method of claim 1, wherein the type of UL transmission to be deployed comprises at least one of: a diversity type transmission, and a multiplexing type transmission.

4. The method of claim 1, wherein the determining the type of UL transmission to be deployed based on the arrival traffic comprises determining the type of UL transmission to be deployed based on a configured logical channel prioritization (LCP) restriction.

5. The method of claim 1, wherein a default type of UL transmission to the network comprises one of: a diversity type transmission, a multiplexing type transmission, and a single panel transmission.

6. The method of claim 1 of 5, wherein upon determining that the type of UL transmission to be deployed differs from a type of UL transmission of a previous transmission or from the default type of UL transmission, switching to the type of UL transmission to be deployed.

7. The method of claim 1, further comprising receiving information from the NW associated with using a primary panel for a first transmission of the same or different TBs.

8. The method of claim 1, further comprising receiving information from the NW associated with using a primary panel for a first transmission of the same or different TBs to support the type of UL transmission to be deployed.

9. The method of claim 1, further comprising receiving information from the NW associated with using one or more secondary panels for one or more second transmissions of the same or different TBs.

10. The method of claim 1, further comprising receiving information from the NW associated with using one or more secondary panels for one or more second transmissions of the same or different TBs to support the type of UL transmission to be deployed.

11. The method of claim 10, wherein the information is an RRC signaling configuration.

12. The method of claim 10, wherein a first transmission is a new transmission of the same or different TBs and the one or more second transmissions are retransmissions of the same or different TBs, and the same HARQ process is associated with the first transmission and the one or more second transmissions.

13. The method of claim 1, further comprising transmitting to the NW a signaling indicating the type of UL transmission to be deployed.

14. A base station, comprising:
at least one memory; and
at least one processor coupled with the at least one memory and configured to cause the base station to:
transmit, to a terminal device, an indication that simultaneous multi-panel transmission is supported by a network (NW);
receive, from the terminal device, a signaling indicating a type of uplink (UL) transmission for one or more transport blocks (TBs); and
receive, from the terminal device, the one or more TBs that are transmitted with the type of UL transmission as indicated by the signaling.

15. The base station of claim 14, wherein the at least one processor is configured to cause the base station to determine one or more hybrid automatic repeat request (HARQ) process indexes (IDs) to support the transmission of the same or different TBs, based on the type of UL transmission.

16. A user equipment (UE), comprising:
at least one memory; and
at least one processor coupled with the at least one memory and configured to cause the UE to:
receive, from a network (NW), an indication that simultaneous multi-panel transmission is supported by the NW;
determine a type of uplink (UL) transmission to be deployed, based on at least a hybrid automatic repeat request (HARQ) feedback or arrival traffic;
configure one or more panels for transmission with the type of UL transmission to be deployed; and
transmit, to the NW, a same transport block (TB) or different transport blocks (TBs) via the type of UL transmission to be deployed using the one or more panels.

17. The UE of claim 16, wherein the at least one processor is configured to cause the UE to determine one or more HARQ process indexes (IDs) to support the transmission of the same or different TBs, based on the type of UL transmission as determined.

18. The UE of claim 16, wherein the type of UL transmission to be deployed comprises at least one of: a diversity type transmission, and a multiplexing type transmission.

19. The UE of claim 16, wherein the determining the type of UL transmission to be deployed based on the arrival traffic comprises determining the type of UL transmission to be deployed based on a configured logical channel prioritization (LCP) restriction.

20. A processor for wireless communication, comprising:
at least one controller coupled with at least one memory and configured to cause the processor to:
receive, from a network (NW), an indication that simultaneous multi-panel transmission is supported by the NW;
determine a type of uplink (UL) transmission to be deployed, based on at least a hybrid automatic repeat request (HARQ) feedback or arrival traffic;
configure one or more panels for transmission with the type of UL transmission to be deployed; and
transmit, to the NW, a same transport block (TB) or different transport blocks (TBs) via the type of UL transmission to be deployed using the one or more panels.
